(19) United States
(12) Patent Application Publication
(10) Pub. No.: US 2006/0124599 A1
(43) Pub. Date: Jun. 15, 2006

(54) Grounding switch having a moveable contact piece

(75) Inventors: Wolfgang Braun, Poxdorf (DE); Manfred Meinherz, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/552,698

(22) PCT Filed: Mar. 12, 2004
(86) PCT No.: PCT/DE04/00558

§ 371 Date: Oct. 7, 2005

(30) Foreign Application Priority Data
Apr. 11, 2003 (DE) 103 17 735.3

(51) Int. Cl. H01H 33/66

(52) U.S. Cl. 218/118

(57) ABSTRACT

A displaceable contact piece of an earthing switch transverses the wall of a housing of a capsule. Said displaceable contact piece is sealed with respect to the capsule housing wall by means of a sealing element. The displaceable contact piece is connected in an electrically conducting manner to the capsule housing wall via the sealing element.

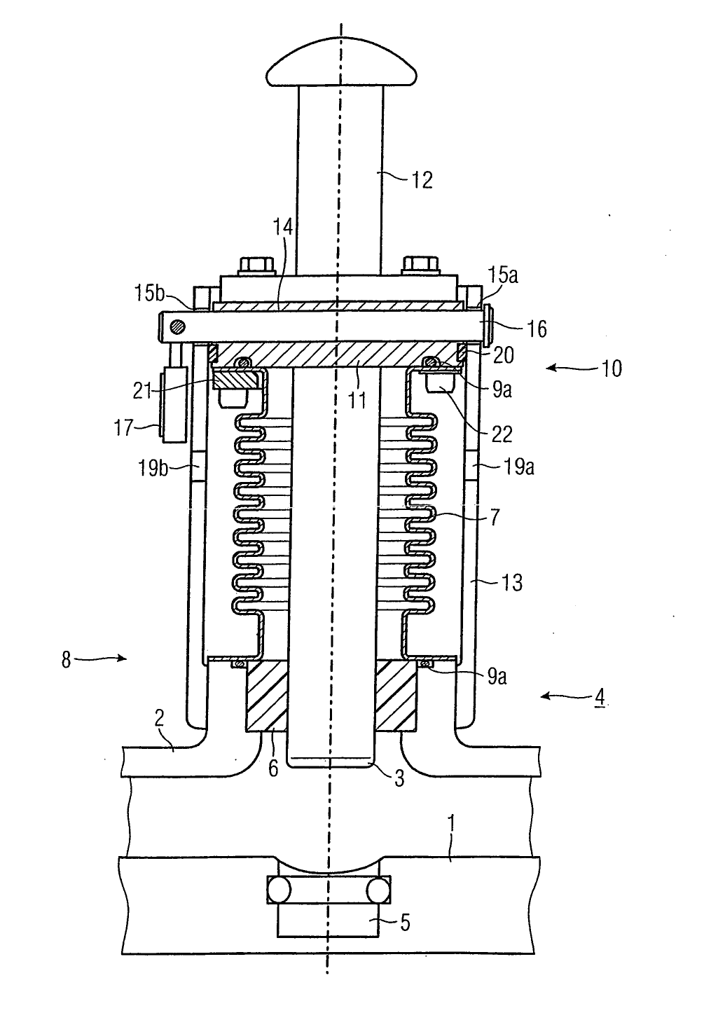

The invention relates to a grounding switch having a moveable contact piece, which passes through an electrically conductive encapsulating housing wall such that it is sealed by means of a sealing element, the moveable contact piece being electrically conductively connected to the encapsulating housing wall via the sealing element in the form of a bellows and being guided in a journal bearing supported on the encapsulating housing.

It is known to use grounding switches having a moveable contact piece for the purpose of grounding a busbar section of an encapsulated compressed gas-insulated switchgear assembly. Since these busbar sections are located in the interior of the encapsulating housing, it is necessary to transfer forces required for driving the moveable contact pieces via complex mechanisms through the encapsulating housing to the moveable contact piece.

The German laid-open specification DE 28 21 049 A1 has disclosed, for example, a hermetically encapsulated insulating gas-filled switchgear assembly having grounding switches. The grounding switches have sealing elements, which are in the form of bellows and seal the moveable contact piece with respect to an encapsulating housing. An electrically conductive connection between the encapsulating housing and the moveable contact piece is produced by means of the bellows. The moveable contact pieces are led to the outside in an electrically conductive manner, with the result that external grounding lines can also be connected to the moveable contact pieces.

It is first necessary to establish safe isolation from the supply before a contact piece is grounded. Then, the external grounding lines are attached to corresponding fixed points. This attachment takes place in this case such that sufficient clearances between the operator and the contact piece to be grounded are always maintained via insulating rods or similar apparatuses. This attachment of external grounding lines is time-consuming and requires technically trained staff owing to the safety regulations to be adhered to.

The present invention is based on the object of operating a grounding switch of the type mentioned initially in a simplified manner.

The object is achieved in the case of a grounding switch of the type mentioned initially according to the invention by the fact that the moveable contact piece can be driven by means of an electrically insulating handle.

The use of the sealing element as an electrical conductor for the purpose of making contact with the moveable contact piece means that a complex electrical connection of the contact piece is superfluous. Designs for connecting the moveable contact piece to a stationary grounding point, for example by means of sliding contacts or flexible contact strips, are thus no longer necessary. As a result, the number of components in the grounding switch is reduced and thus a simplified design is provided. The physical size of the grounding switch is thus also reduced. A bellows provides the advantage that it permits an axial movement through a housing wall. At the same time, a comparatively large conductor

cross section is made available by the bellows for the purpose of dissipating a short-circuit ground current. A journal bearing makes it possible to guide the moveable contact piece in a cost-effective manner. Here, provision may be made in a simple case for the journal bearing to be in the form of an insulating material bushing. As a result, the interior of the encapsulating housing is closed off mechanically from the area which serves the purpose of accommodating the contact piece passed through the wall. No foreign particles can thus migrate over this boundary from one area to the other. This journal bearing thus means that a form of barrier is formed. Since this barrier is not gas-tight, however, insulating gas which is located, for example, in the interior of the encapsulating housing can continue to flow through the journal bearing. Dielectric strength is thus ensured.

Owing to the use of a handle, it is possible to produce a cost-effective grounding switch since complex electromechanical drive devices are not required. Owing to the electrically insulating design of the handle, an operator is protected against an electrical flow which could occur, for example, in the case of faulty operation of the grounding switch. When a bellows is used, the handle may have an extremely simple design since a movement of the moveable contact piece in the axial direction can be transferred from the handle directly to the contact piece. Deflecting gear mechanisms, levers etc. are thus avoided.

Provision may advantageously also be made for the insulating handle to be mounted such that it can slide in a guide element. The sliding mounting of the handle in a guide element makes it possible for the grounding switch to be kept free of shafts, axles or other rotating elements even on the drive side. The guide element may in this case be designed such that it surrounds the bellows. The guide element may be tubular, for example, and flange-mounted on the encapsulating housing wall. In this case, the guide element may at the same time be used for the purpose of accommodating a locking device of the grounding switch.

One exemplary embodiment of the invention will be shown schematically in a drawing below and described in more detail in the text which follows.

In the drawing

the FIGURE shows a section through a grounding switch having a moveable contact piece.

The FIGURE illustrates a section of an encapsulating housing of a compressed gas-insulated switchgear assembly. An electrical conductor 1 is mounted such that it is insulated in the interior of the encapsulating housing. The encapsulating housing is filled with an electronegative gas at an elevated pressure for insulating purposes. A moveable contact piece 3 of a grounding switch 4 passes through an encapsulating housing wall 2. The encapsulating housing wall 2 is produced from an electrically conductive material, for example aluminum, and has a ground potential. The moveable contact piece 3 is in the form of a bolt and can be displaced along its axis of rotation. The moveable contact piece 3 is moved into an opposing contact 5 located on the electrical conductor 1 when the grounding switch 4 is in the switched-on position. The moveable

contact piece 3 is mounted in a journal bearing 6. The journal bearing 6 is in the form of an insulating bushing and offers mechanical protection against the ingress of foreign particles, which may arise in the region of the drive of the grounding switch 4, into the interior of the encapsulating housing. In order to seal the moveable contact piece 3 in a gas-tight manner with respect to the encapsulating housing wall 2, a bellows 7 is arranged coaxially with respect to the moveable contact piece 3. The bellows 7 is connected at its first end 8 in a gas-tight and electrically conductive manner to the encapsulating housing wall 2. For sealing purposes, an O ring 9a is introduced at the join between the encapsulating housing wall 2 and the bellows 7. At the second end 10, which is remote from the first end 8, the bellows 7 is electrically conductively connected to a cylindrical plate 11. This connection may be designed such that it can be isolated, in which case a gas-tight connection between the cylindrical plate 11 and the bellows 7 owing to an O ring 9a is maintained. A circumferential pressure ring 21, which is pressed on with few screws, or a large number of screws 22 arranged on the circumference of the bellows 7, for example, can be used to press the bellows 7 against the cylindrical plate 11 or against the encapsulating housing wall 2. The opening in the encapsulating housing wall 2, through which the moveable contact piece 3 passes, is sealed in a gas-tight manner by means of the bellows 7 and the cylindrical plate 11.

An insulating handle 12 is arranged on that surface of the cylindrical plate 11 which faces away from the moveable contact piece 3. The moveable contact piece 3 can be moved from its switched-off position into its switched-on position, and vice versa, by means of the insulating handle 12. The FIGURE illustrates the grounding switch 4 in its switched-off position.

In order to guide the insulating handle 12, the cylindrical plate 11 is mounted such that it can be displaced within a hollow cylinder 13, which acts as a guide element. The cylindrical plate 11 is mounted such that it can slide in the hollow cylinder 13 by means of a circumferential plastic ring 20. The hollow cylinder 13 protects the bellows 7 against external mechanical influences. Furthermore, the cylindrical plate 11 has an opening 14, which lies perpendicular to the movement direction of the moveable contact piece 3. The opening 14 is aligned with a first pair of openings 15a,b in the switched-off position of the grounding switch 4, with the result that a locking bolt 16 can be pushed into the opening 14 through the first pair of openings 15a,b. The locking bolt 16 can be locked by means of a padlock 18, with the result that a movement of the moveable contact piece 3 is only made possible once the padlock 18 has been unlocked and the locking bolt 16 has been removed. Furthermore, a second pair of openings 19a,b is introduced into the hollow cylinder 13, the opening 14 being aligned with said pair of openings 19a,b in the switched-on state of the grounding switch 4, with the result that, even in the switched-on state of the grounding switch 4, it is possible to lock the moveable contact piece 3 by means of the locking bolt 16.

In the switched-on position, an electrically conductive connection between the electrical conductor 1 and the encapsulating housing wall 2, carrying the ground potential, is produced between the electrical conductor 1 via the opposing contact 5, into which the moveable contact piece 3 is moved, via the moveable contact piece 3, also via the cylindrical plate 11 and the bellows 7, which is in electrical contact with the cylindrical plate 11, and via the electrical contact between the bellows 7 and the encapsulating housing wall 2. The bellows 7,

which is made from an electrically conductive material, for example a metal, is part of the grounding current path. Provision may also be made for additional conductor connections, such as conductor cables, to be used to increase the current-carrying capacity of the bellows 7.

1. A grounding switch comprising a moveable contact piece, which passes through an electrically conductive encapsulating housing wall such that it is sealed by means of a sealing element,
the moveable contact piece being electrically conductively connected to the encapsulating housing wall via the sealing element in the form of a bellows and being guided in a journal bearing supported on the encapsulating housing,
wherein
the moveable contact piece can be driven by means of an electrically insulating handle.

2. The grounding switch as claimed in claim 1,
wherein
the insulating handle is mounted such that it can slide in a guide element.
